(19) United States
(12) Patent Application Publication
(10) Pub. No.: US 2026/0268530 A1
(43) Pub. Date: Sep. 10, 2026

(54) METHOD AND APPARATUS FOR STORING VISUAL MEDIA DATA

(71) Applicant: Nokia Technologies Oy, Espoo (FI)

(72) Inventors: Lauri Aleksi ILOLA, Tampere (FI); Lukasz KONDRAD, Munich (DE); Emre Baris AKSU, Tampere (FI); Kashyap KAMMACHI SREEDHAR, Tampere (FI)

(21) Appl. No.: 19/540,950

(22) Filed: Feb. 16, 2026

Related U.S. Application Data
(60) Provisional application No. 63/759,894, filed on Feb. 18, 2025.

(51) Int. Cl. G06T 9/00; G06T 11/00

(52) U.S. Cl. CPC G06T 9/001; G06T 11/00; G06T 2210/22; G06T 2210/56

(57) ABSTRACT

The embodiments concern a method and an apparatus for editing, comprising receiving one or more frames of visual media data; receiving editing instructions for the one or more frames of visual media data; recording original parameters of the one or more frames of visual media data; applying editing operations according to the editing instructions to the one or more frames of visual media data to generate one or more modified fames of visual media data; and storing the one or more modified frames of visual media data in a file along with the applied editing instructions and the original parameters of the one or more frames of visual media data. The embodiments also concern a method and an apparatus for parsing the file to extract one of more frames and to edit them according to the editing instructions.

### TECHNICAL FIELD

The present solution relates generally to storing visual media data such as videos and/or images, in a file.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video codec comprises an encoder and a decoder. The encoder transforms an input video into a compressed representation suited for storage and/or transmission. The decoder decompresses the compressed video representation back into a viewable form. During encoding, the encoder may discard some information in the original video sequence to be able to represent the video in a more compact form (that is, at lower bitrate).

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising at least one processor and at least one memory, said at least one memory stored with code thereon, which when executed by said at least one processor, causes the apparatus to receive one or more frames of visual media data; receive editing instructions for the one or more frames of visual media data; record original parameters of the one or more frames of visual media data; apply editing operations according to the editing instructions to the one or more frames of visual media data to generate one or more modified frames of visual media data; and store the one or more modified frames of visual media data in a file along with the applied editing instructions and the original parameters of the one or more frames of visual media data.

According to a second aspect, there is provided a method for encoding comprising receiving one or more frames of visual media data; receiving editing instructions for the one or more frames of visual media data; recording original parameters of the one or more frames of visual media data; applying editing operations according to the editing instructions to the one or more frames of visual media data to generate one or more modified frames of visual media data; and storing the one or more modified frames of visual media data in a file along with the applied editing instructions and the original parameters of the one or more frames of visual media data.

According to a third aspect, there is provided an apparatus for encoding comprising means for receiving one or more frames of visual media data; means for receiving editing instructions for the one or more frames of visual media data; means for recording original parameters of the one or more frames of visual media data; means for applying editing operations according to the editing instructions to the one or more frames of visual media data to generate one or more modified frames of visual media data; and means for storing the one or more modified frames of visual media data in a file along with the applied editing instructions and the original parameters of the one or more frames of visual media data.

According to a fourth aspect, there is provided computer program product for encoding comprising computer program code configured to, when executed on at least one processor, cause an apparatus or a system to receive one or more frames of visual media data; receive editing instructions for the one or more frames of visual media data; record original parameters of the one or more frames of visual media data; apply editing operations according to the editing instructions to the one or more frames of visual media data to generate one or more modified frames of visual media data; and store the one or more modified frames of visual media data in a file along with the applied editing instructions and the original parameters of the one or more frames of visual media data.

According to an embodiment for any of the previous aspects, the one or more frames of visual media are received as an encoded bitstream.

According to an embodiment for any of the previous aspects and/or embodiment, the one or more modified frames of visual media are encoded into a bitstream and stored in a file.

According to an embodiment for any of the previous aspects and/or embodiments, the editing instructions comprises cropping operation.

According to an embodiment for the previous embodiment, the cropping operation is parameterized by at least one set of vertical and horizontal offset of a cropped region and width and height of the cropped region in the original frame of visual media data.

According to an embodiment for any of the previous aspects and/or embodiments, the file is structured according to ISO base media file format.

According to an embodiment for any of the previous aspects and/or embodiments, the file comprises a box for storing the applied editing instructions.

According to an embodiment for any of the previous aspects and/or embodiments, the box comprises one or more of the following: cropping information; rotation information; skewing information; scaling information; color transformation information; sharpening information; blurring information; depth transformation information.

According to an embodiment for any of the previous aspects and/or embodiments, the editing information is stored in the encoded bitstream as supplementary enhancement information messages.

According to an embodiment for any of the previous aspects and/or embodiments, the following is stored: the applied editing instruction history for the one or more frames of visual media data, the history describing the applied editing instructions and the order of the applied editing instructions.

According to an embodiment for any of the previous aspects and/or embodiments, the computer program product is embodied on a non-transitory computer readable medium.

According to a fifth aspect, there is provided an apparatus for decoding comprising at least one processor and at least one memory, said at least one memory stored with code thereon, which when executed by said at least one processor, causes the apparatus to receive a file, said file consisting of one or more frames of visual media data, zero or more editing instructions per frame of visual media data, and original parameters of the one or more frames of visual media data; parse structures of the file to extract the one or more frames of visual media data; parse the structures of the file to determine whether editing operations have been applied to the one or more frames of visual media data; parse the structures of the file to determine the original parameters of the one or more frames of visual media data; and pass at least the one or more frames of visual media data, the editing instructions if any, and the original parameters of the one or more frames of visual media data to an application.

According to a sixth aspect, there is provided a method for decoding comprising receiving a file, said file consisting of one or more frames of visual media data, zero or more editing instructions per frame of visual media data, and original parameters of the one or more frames of visual media data; parsing structures of the file to extract the one or more frames of visual media data; parsing the structures of the file to determine whether editing operations have been applied to the one or more frames of visual media data; parsing the structures of the file to determine the original parameters of the one or more frames of visual media data; and passing at least the one or more frames of visual media data, the editing instructions if any, and the original parameters of the one or more frames of visual media data to an application.

According to a seventh aspect, there is provided an apparatus comprising at least means for receiving a file, said file consisting of one or more frames of visual media data, zero or more editing instructions per frame of visual media data, and original parameters of the one or more frames of visual media data; means for parsing structures of the file to extract the one or more frames of visual media data; means for parsing the structures of the file to determine whether editing operations have been applied to the one or more frames of visual media data; means for parsing the structures of the file to determine the original parameters of the one or more frames of visual media data; and means for passing at least the one or more frames of visual media data, the editing instructions if any, and the original parameters of the one or more frames of visual media data to an application.

According to an eighth aspect, there is provided computer program product for decoding comprising computer program code configured to, when executed on at least one processor, cause an apparatus or a system to receive a file, said file consisting of one or more frames of visual media data, zero or more editing instructions per frame of visual media data, and original parameters of the one or more frames of visual media data; parse structures of the file to extract the one or more frames of visual media data; parse the structures of the file to determine whether editing operations have been applied to the one or more frames of visual media data; parse the structures of the file to determine the original parameters of the one or more frames of visual media data; and pass at least the one or more frames of visual media data, the editing instructions if any, and the original parameters of the one or more frames of visual media data to an application.

According to an embodiment for any of the previous aspects, editing instructions comprises cropping operation.

According to an embodiment for any of the previous aspects and/or embodiment, the cropping operation is parameterized by at least one set of vertical and horizontal offset of a cropped region and width and height of the cropped region in the original frame of visual media data.

According to an embodiment for any of the previous aspects and/or embodiments, the file is structured according to ISO base media file format.

According to an embodiment for any of the previous aspects and/or embodiments, the file comprises a box for storing the applied editing instructions.

According to an embodiment for any of the previous aspects and/or embodiments, the box comprises one or more of the following: cropping information; rotation information; skewing information; scaling information; color transformation information; sharpening information; blurring information; depth transformation information. According to an embodiment for any of the previous aspects and/or embodiments, the following is stored: the applied editing instruction history for the one or more frames of visual media data, the history describing the applied editing instructions and the order of the applied editing instructions.

According to an embodiment for any of the previous aspects and/or embodiments, the computer program product is embodied on a non-transitory computer readable medium.

### BRIEF DESCRIPTION OF THE DRAWINGS

For a more complete understanding of example embodiments of the present invention, reference is now made to the following descriptions taken in connection with the accompanying drawings in which:

FIG. 1 shows an overview of a V-DMC encoder;

FIGS. 2a and 2b illustrate an example of an editing operation, particularly of image cropping;

FIG. 3 is a flow diagram showing a method for encoding according to an embodiment;

FIG. 4 is a flow diagram showing a method for decoding according to an embodiment;

FIG. 5 shows an apparatus according to an embodiment; and

FIG. 6 shows a schematic diagram of an example multimedia communication system within which various embodiments may be implemented.

### DETAILED DESCRIPTION OF THE DRAWINGS

The following description and drawings are illustrative and are not to be construed as unnecessarily limiting. The specific details are provided for a thorough understanding of the disclosure. However, in certain instances, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure.

Present embodiments relate to storing and signaling parameters and editing instruction concerning frames of visual media data (i.e., image or video frames) in a file format. Before describing the embodiments further, a brief reference to related technology is given.

### ISOBMFF-ISO/IEC 14496-12

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four character code (4CC) and starts with a header which informs about the type and size of the box.

Many files formatted according to the ISO base media file format start with a file type box, also referred to as FileTypeBox or the ‘ftyp’ box. The ftyp box contains information of the brands labeling the file. The ‘ftyp’ box includes one major brand indication and a list of compatible brands. The major brand identifies the most suitable file format specification to be used for parsing the file. The compatible brands indicate which file format specifications and/or conformance points the file conforms to. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ‘ftyp’ box. A file player may check if the ‘ftyp’ box of a file comprises brands it supports, and may parse and play the file only if any file format specification supported by the file player is listed among the compatible brands.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames, or metadata frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleTableBox (also known as the sample table or the sample table box). The SampleTableBox contains the SampleDescriptionBox, which gives detailed information about the coding type used, and any initialization information needed for that coding. The SampleDescriptionBox contains an entry-count and as many sample entries as the entry-count indicates. The format of sample entries is track-type specific but derive from generic classes (e.g. VisualSampleEntry, AudioSampleEntry, Volumetric VisualSampleEntry). The type of sample entry form used for derivation the track-type specific sample entry format is determined by the media handler of the track.

A TrackTypeBox may be contained in a TrackBox. The payload of Track TypeBox has the same syntax as the payload of FileTypeBox. The content of an instance of TrackTypeBox shall be such that it would apply as the content of FileTypeBox, if all other tracks of the file were removed and only the track containing this box remained in the file.

Movie fragments may be used, for example, when recording content to ISO files, for example, in order to avoid losing data if a recording application crashes, runs out of memory space, or some other incident occurs. Without movie fragments, data loss may occur because the file format may require that all metadata, for example, a movie box, be written in one contiguous area of the file. Furthermore, when recording a file, there may not be sufficient amount of memory space to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an ‘mdat’ box. For the metadata of the movie fragments, however, a ‘moof’ box may be provided. The ‘moof’ box may include the information for a certain duration of playback time that would previously have been in the ‘moov’ box. The ‘moov’ box may still represent a valid movie on its own, but in addition, it may include an ‘mvex’ box indicating that movie fragments will follow in the same file. The movie fragments may extend the presentation that is associated to the ‘moov’ box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the ‘moof’ box may be limited to a subset of the metadata that may be included in a ‘moov’ box and may be coded differently in some cases. Details regarding the boxes that can be included in a ‘moof’ box may be found from the ISOBMFF specification.

A self-contained movie fragment may be defined to consist of a ‘moof’ box and an ‘mdat’ box that are consecutive in the file order and where the ‘mdat’ box contains the samples of the movie fragment (for which the ‘moof’ box provides the metadata) and does not contain samples of any other movie fragment (i.e., any other ‘moof’ box). A media segment may comprise one or more self-contained movie fragments. A media segment may be used for delivery, such as streaming, e.g., in MPEG-Dynamic Adaptive Streaming over Hypertext Transfer Protocol (HTTP) (MPEG-DASH).

The track reference mechanism can be used to associate tracks with each other. The TrackReferenceBox includes box(es), each of which provides a reference from the containing track to a set of other tracks. These references are labelled through the box type (i.e., the four-character code of the box) of the contained box(es). The ISO Base Media File Format contains three mechanisms for timed metadata that can be associated with particular samples: sample groups, timed metadata tracks, and sample auxiliary information. Derived specification may provide similar functionality with one or more of these three mechanisms.

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group. The syntax of the contained boxes may be defined through TrackGroupTypeBox is follows:

```
aligned(8) class TrackGroupTypeBox(unsigned int(32) track_group_type)
extends FullBox(track_group_type, version = 0, flags = 0)
{
  unsigned int(32) track_group_id;
  // the remaining data may be specified //for a
  particular track_group_type}
```

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (‘sbgp’ box) represents the assignment of samples to sample groups; and (2) a SampleGroupDescriptionBox (‘sgpd’ box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g., to indicate a sub-type of the grouping.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is stored in the same file as the samples to which it relates as they share the same data reference (‘dref’) structure. However, this data may be located anywhere within this file, using auxiliary information offsets (‘saio’) to indicate the location of the data.

The restricted video (‘resv’) sample entry and mechanism has been specified for the ISOBMFF in order to handle situations where the file author requires certain actions on the player or renderer after decoding of a visual track. Players not recognizing or not capable of processing the required actions are stopped from decoding or rendering the restricted video tracks. The ‘resv’ sample entry mechanism applies to any type of video codec. A RestrictedSchemeInfoBox is present in the sample entry of ‘resv’ tracks and comprises an OriginalFormatBox, SchemeTypeBox, and SchemeInformationBox. The original sample entry type that would have been unless the ‘resv’ sample entry type were used is contained in the OriginalFormatBox. The SchemeTypeBox provides an indication which type of processing is required in the player to process the video. The SchemeInformationBox comprises further information of the required processing. The scheme type may impose requirements on the contents of the SchemeInformationBox. For example, the stereo video scheme indicated in the SchemeTypeBox indicates that when decoded frames either contain a representation of two spatially packed constituent frames that form a stereo pair (frame packing) or only one view of a stereo pair (left and right views in different tracks). StereoVideoBox may be contained in SchemeInformationBox to provide further information e.g. on which type of frame packing arrangement has been used (e.g., side-by-side or top-bottom).

Several types of stream access points (SAPs) have been specified, including the following. SAP Type 1 corresponds to what is known in some coding schemes as a “Closed group of pictures (GOP) random access point” (in which all pictures, in decoding order, can be correctly decoded, resulting in a continuous time sequence of correctly decoded pictures with no gaps) and in addition the first picture in decoding order is also the first picture in presentation order. SAP Type 2 corresponds to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 corresponds to what is known in some coding schemes as an “Open GOP random access point”, in which there may be some pictures in decoding order that cannot be correctly decoded and have presentation times less than intra-coded picture associated with the SAP.

A stream access point (SAP) sample group as specified in ISOBMFF identifies samples as being of the indicated SAP type.

A sync sample may be defined as a sample corresponding to SAP type 1 or 2. A sync sample can be regarded as a media sample that starts a new independent sequence of samples; if decoding starts at the sync sample, it and succeeding samples in decoding order can all be correctly decoded, and the resulting set of decoded samples forms the correct presentation of the media starting at the decoded sample that has the earliest composition time. Sync samples can be indicated with the SyncSampleBox (for those samples whose metadata is present in a TrackBox) or within sample flags indicated or inferred for track fragment runs.

### ISO/IEC 23008-12

This standard defines the Image File Format, an interoperable storage format for a single image, a collection of images, and sequences of images. The format defined in this document is built on tools defined in ISO/IEC 14496-12 and enables the interchanged, editing and display of images, as well as carriage of metadata associated with those images. The Image File Format defines structures used to contain metadata, how to link the metadata to the images, and how metadata of certain formats is carried. Also, the document specifies brands for storage of images and image sequences conforming to High Efficiency Video Coding (HEVC), Advanced Video Coding (AVC), JPEG, Versatile Video Coding (VVC), and Essential Video Coding (EVC).

### ISO/IEC 23001-16

This standard defines a storage format for derived visual tracks and an initial set of transformation operations, facilitating the interchange, editing, and display of timed sequences of images resulting from transformations applied to input still images or sequences of images within the same presentation. Derived visual tracks are either video or picture tracks identified by the sample entry type ‘dtrk’ and describe a timed sequence of derived samples composed of an ordered list of derivation operations. These operations are represented by a container box of type ‘dimg’, which includes a derivation transformation box and can carry VisualDerivationInputs, identified by a 32-bit value (four-character code).

The standard outlines several potential derived visual types, including Identity (reproduces the visual input), sRGB Fill (generates a single color output), Dissolve (smoothly blends two visual inputs), Crop (defines a cropping transformation), Rotation (rotates the visual input in 90-degree increments), Mirror (mirrors the visual input horizontally or vertically), Scaling (scales the visual input to a target size), Region of Interest (ROI) Selection (crops the visual input based on 2D Cartesian coordinates), Grid Composition (arranges visual inputs in a grid format), and Overlay Composition (overlays one visual input over another using specified offsets). The sample entry for a derived visual track is defined as DerivedVisualSampleEntry, which includes a DerivedVisualTrackConfigRecord containing default inputs and parameter values for the derivation operations.

Usage examples provided in the standard illustrate sequences of derived samples, chains of derivation operations within a single derived sample, and overlays of visual inputs. Normative references include ISO/IEC 14496-12 (ISO Base Media file format), ISO/IEC 23001-10 (Carriage of timed metadata metrics of media in ISO base media file format), and ISO/IEC 23008-12 (Image File Format). Key terms and definitions include derivation operation (an operation applying a transformation to an ordered list of inputs), derived sample (contains an ordered list of derivation operations), derived visual track (contains a timed sequence of derived samples), input (parameter input or visual input), and visual output (one video frame or a sequence of video frames resulting from a derivation transformation). This standard provides a comprehensive framework for creating and managing derived visual tracks, ensuring consistency and interoperability across different platforms and applications.

### Volumetric Video

Volumetric video data represents a three-dimensional (3D) scene or object, and can be used as input for AR (Augmented Reality), VR (Virtual Reality), and MR (Mixed Reality) applications. Such data describes geometry (shape, size, position in 3D space) and respective attributes (e.g., color, opacity, reflectance, etc.), and any possible temporal transformations of the geometry and attributes at given time instances (like frames in two-dimensional (2D) video). Volumetric video can be generated from 3D models, also referred to as volumetric visual objects, i.e., CGI (Computer Generated Imagery), or captured from real-world scenes using a variety of capture solutions, e.g., multi-camera, laser scan, combination of video and dedicated depth sensors, and more. Also, a combination of CGI and real-world data is possible. Examples of representation formats for volumetric data comprise triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF (SixDegrees Of Freedom) viewing capabilities.

Increasing computational resources and advances in 3D data acquisition devices have enabled reconstruction of highly detailed volumetric video representations of natural scenes. Infrared, lasers, time-of-flight, and structured light are examples of devices that can be used to construct 3D video data. Representation of the 3D data depends on how the 3D data is used. Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding, this 3D data as set of texture and depth map as is the case in the multi-view plus depth. Closely related to the techniques used in multi-view plus depth is the use of elevation maps, and multi-level surface maps.

There are many ways to capture and represent a volumetric frame. The format used to capture and represent the volumetric frame depends on the processing to be performed on the frame, and the target application using the frame. Some examples are listed in the following:
A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA (Red, Green, Blue, Alpha) value, or normal vectors)
A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsics and intrinsics). Each view may be represented by a number of components (e.g. geometry, color, transparency, and occupancy picture), which may be part of the geometry picture or represented separately.
A volumetric frame can be represented as a mesh. Mesh is a collection of points, called vertices, and connectivity information between vertices, called edges. Vertices along with edges form faces. The combination of vertices, edges and faces can uniquely approximate shapes of objects.
Volumetric frame can be represented as a various N-dimensional primitives, cubes (voxels), spheres, ellipsoids, planes, convex hulls, etc. with various geometric and visual/appearance attributes. Example of one widely used such primitives could be 3D Gaussians.
Volumetric frame can be represented as an implicit neural representations like neural radiance fields (NeRFs).

Depending on the capture, a volumetric frame can provide viewers the ability to navigate a scene with 6DOF, i.e., both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MPEG Immersive Video (MIV) (ISO/IEC 23090-12). MIV and V-PCC use number of V3C syntax elements with a slightly modified semantics. An example on how the generic syntax element can be differently interpreted by the application is pdu_projection_id.
In case of V-PCC the syntax element, pdu_projection_id specifies the index of the projection plane for the patch. There can be 6 or 18 projection planes in V-PCC, and they are implicit, i.e. pre-determined.
In case of MIV, pdu_projection_id corresponds to a view identifier (ID), i.e., it identifies which view the patch originates from. View IDs and their related information are explicitly provided in MIV view parameters list and may be tailored for each content.

MPEG 3DG (ISO SC29 WG7) group works on a third application of V3C, i.e., the mesh compression. It is envisaged that mesh coding will re-use V3C syntax as much as possible and can also slightly modify the semantics.

To differentiate between applications of V3C bitstream, that allows a client to properly interpret the decoded data, V3C may use the ptl_profile_toolset_idc parameter.

### V3C-V3C Bitstream

V3C bitstream is a sequence of bits that forms the representation of coded volumetric frames and the associated data generating one or more coded V3C sequences (CVS). CVS is a sequence of bits identified and separated by appropriate delimiters, and is required to start with a VPS. CVS includes a V3C unit, and contains one or more V3C units with atlas sub-bitstream or video sub-bitstream. Video sub-bitstreams and atlas sub-bitstreams can be referred to as V3C sub-bitstreams. V3C unit header in conjunction with VPS information identifies which V3C sub-bitstream a V3C unit contains and how it is interpreted

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

### Video-Based Dynamic Mesh Coding (V-DMC)—ISO/IEC 23090-29

V-DMC (ISO/IEC 23090-29) is an application form of V3C that aims on integration of mesh compression into the V3C family of standards. The standard is under development and at DIS stage (MDS24469_WG07_N01027).

The technology is based on multiresolution mesh analysis and coding. This approach consists of:
Generating a base-mesh that is a simplified (low resolution) mesh approximation of the original mesh, called base-mesh (this is done for all frames of the dynamic mesh sequence);
Performing several mesh subdivision iterative steps (e.g., each triangle is converted into four triangles by connecting the triangle edge midpoints on the generated base mesh, generating other approximation meshes);
Defining displacement vectors, also named error vectors, for each vertex of each mesh approximation. Each approximation can be seen as level of details (LoD) of the original mesh.
For each subdivision level by adding the displacement vectors to the subdivided mesh vertices generates the best approximation of the original mesh at that resolution, given the base-mesh and prior subdivision levels.
The displacement vectors may undergo a lazy wavelet transform prior to compression.
The attribute map of the original mesh is transferred to the deformed mesh at the highest resolution (i.e., subdivision level) such that texture coordinates are obtained for the deformed mesh and a new attribute map is generated.

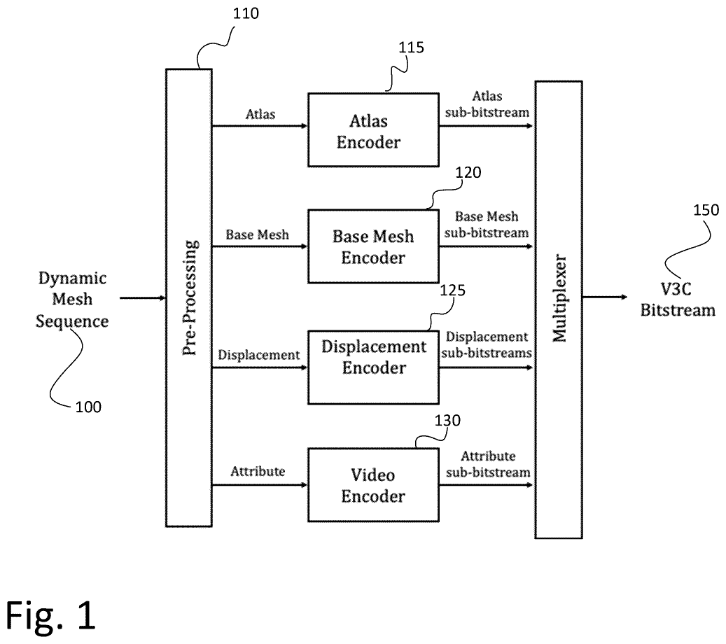

FIG. 1 is an overview of V-DMC encoder. The V-DMC takes dynamic mesh sequence 100 as input and pre-processes 110 the input 100 into multiple representations. These representations include base mesh, a set of displacements, and attributes. The base mesh component represents a simplified version of the detailed mesh describing the object. The displacement component provides displacement vectors which should be applied to the base mesh to obtain the detailed mesh. The attribute components can provide additional properties (e.g., texture or material information). The atlas component provides information to a V3C decoding and rendering system on how to perform inverse reconstruction. Each of the components are encoded in corresponding encoder 115, 120, 125, 130. The V-DMC encoder generates compressed bitstreams which are packet into a V3C bitstream 150 to be provided as an output. The V3C bitstream 150 groups the atlas bitstream and three video components bitstreams, i.e., attribute bitstreams, base mesh bitstream, and displacement bitstream.

V3C bitstream may contain the following units:
A sub-bitstream with the encoded base-mesh using a mesh codec
A sub-bitstream with the displacement vectors:
   packed in an 2D frame and encoded using a video codec or image codec, or
   arithmetic encoded as defined in Annex J of WD ISO/IEC 23090-29,
A sub-bitstream with the attribute map encoded using a video codec
A sub-bitstream (atlas) that contains the metadata required to decode and reconstruct the mesh sequence based on the aforementioned sub-bitstreams. The signaling of the metadata is based on the V3C syntax and includes necessary extensions that are specific to meshes.

### Editing Operation for an Image

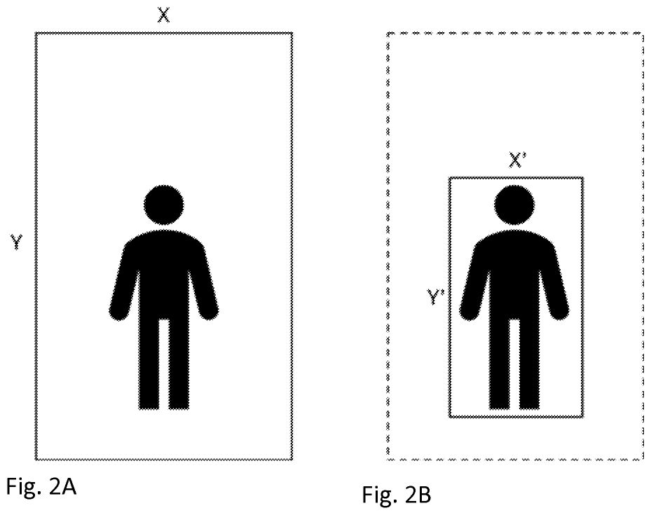

An example of an editing operation performed on an image or video frame is cropping. Cropping refers to a process, where extents of a captured frame are removed. For example, cropping can be used to better focus on a subject, by eliminating distractions or irrelevant pixels in the frame. In another example, cropping can be used to remove pixels that do not contribute to the intention of the image. In yet another example, cropping may be used to retain only the region-of-interest of an image. Furthermore, there can be artistic reasons for image cropping, such as achieving a targeted image aspect ratio, improving image composition or achieving overall better aesthetics. FIGS. 2a and 2b illustrate an example of image cropping. In FIG. 2a, an original image is shown with width X and height Y. The cropped image is shown in FIG. 2b, where the cropped image has width X′ and height Y′.

Cropping is to some extent referred in the previous standards. For example, ISO/IEC 14496-12 specifies the timing, structure, and media information for timed sequences of media data, such as audio-visual presentations. The document also includes definitions for CleanApertureBox, which is used for specifying clean aperture of the video. ISO/IEC 23008-12 specifies the Image File Format, and uses CleanApertureBox for handling cropped image and image sequences. ISO/IEC 23001-16 defines a storage format for derived visual tracks and an initial set of transformation operations. The standard outlines several potential derived visual types, including Crop that defines a cropping transformation.

### Pixel Aspect Ratio and Clean Aperture

CleanApertureBox and PixelAspectRationBox specify clean aperture of the video and the pixel aspect ratio, respectively. Both of these are optional; if present, they will over-ride the declarations (if any) in structures specific to the video codec, which structures should be examined if these boxes are absent. For maximum compatibility, these boxes should follow, not precede, any boxes defined in or required by derived specifications.

The PixelAspectRatioBox is informative; if the decoded output of the codec is re-formatted to the dimensions in the track header, this will accomplish any needed adjustment to a uniformly-scaled grid.

In the PixelAspectRatioBox, hSpacing and vSpacing have the same units, but those units are unspecified: only the ratio matters. hSpacing and vSpacing may or may not be in reduced terms, and they may reduce to 1/1. Both hSpacing and vSpacing are strictly positive.

The pixel aspect ratio should not be confused with the picture aspect ratio, also known as the display aspect ratio, which is the ratio of the width to the height of the final displayed image (e.g. 16:9).

They are defined as the aspect ratio of a pixel, in arbitrary units. If a pixel appears H wide and V tall, then hSpacing/vSpacing is equal to H/V. This means that a square on the display that is n pixels tall needs to be n*vSpacing/hSpacing pixels wide to appear square.

There are notionally four values in the CleanApertureBox. These parameters are represented as a fraction N/D. The fraction may or may not be in reduced terms. The pair of parameters fooN and fooD are referred to as foo. For horizOff and vertOff, D shall be strictly positive and N may be positive or negative. For cleanApertureWidth and cleanApertureHeight, N shall be positive and D shall be strictly positive.

These are fractional numbers for several reasons. First, in some systems the exact width after pixel aspect ratio correction is integral, not the pixel count before that correction. Second, if video is resized in the full aperture, the exact expression for the clean aperture might not be integral. Finally, because this is represented using centre and offset, a division by two is needed, and so half-values can occur.

Considering the pixel dimensions as defined by the VisualSampleEntry width and height. If picture centre of the image is at pcX and pcY, then horizOff and vertOff are defined as follows:

$$pcX = horiOff + ( width - 1 ) / 2 \\ pcY = vertOff + ( height - 1 ) / 2 ;$$

horizOff and vertOff are typically zero, so the image is centred about the picture centre.

The leftmost/rightmost pixel and the topmost/bottommost line of the clean aperture fall at:

$$pcX \pm ( cleanAperatureWidth - 1 ) / 2 \\ pcY \pm ( cleanApertureHeight - 1 ) / 2 ;$$

The cropping implied by the CleanApertureBox is applied before any transformation defined by track or movie matrices.

Syntax may be as follows:

```
class PixelAspectRatioBox extends Box(‘pasp’){
  unsigned int(32) hSpacing;
  unsigned int(32) vSpacing;}
class CleanApertureBox extends Box(‘clap’){
  unsigned int(32) cleanApertureWidthN;
  unsigned int(32) cleanApertureWidthD;
  unsigned int(32) cleanApertureHeightN;
  unsigned int(32) cleanApertureHeightD;
  unsigned int(32) horizOffN;
  unsigned int(32) horizOffD;
  unsigned int(32) vertOffN;
  unsigned int(32) vertOffD;
}
```

wherein
hSpacing, vSpacing define the relative width and height of a pixel;
cleanApertureWidthN, cleanApertureWidthD is a fractional number which defines the width of the clean aperture image
cleanApertureHeightN, cleanApertureHeightD is a fractional number which defines the height of the clean aperture image
horizOffN, horizOffD is a fractional number which defines the horizontal offset between the clean aperture image centre and the full aperture image centre. Typically, the number is 0.
vertOffN, vertOffD is a fractional number which defines the vertical offset between clean aperture image centre and the full aperture image centre. Typically, the number is 0.

### SEI Messages

In video coding, SEI stands for Supplemental Enhancement Information. It refers to additional data included in a video stream to provide extra information that helps with things like video playback, decoding, or enhanced features. These messages are not part of the primary video content (i.e., the compressed video frames themselves) but serve as supplementary metadata that can assist decoders or other video processing systems. SEI messages can be interleaved in the coded video bitstreams as they too are constructed as Network Abstraction Layer units (NAL). Video codecs may be able to extract these from the encoded bitstreams but are not mandated to.

SEI messages are part of the H.264 and H.265/HEVC (High-Efficiency Video Coding) standards (and some other standards too) and can be used for various purposes. Recently work on Versatile SEI messages (VSEI) have been started. VSEI messages are considered more flexible form of SEI messages, not tied to a particular video coding format.

Reprojection of Images into 3D

Reprojecting images with texture and depth into 3D space as a point cloud is a common process in computer vision and photogrammetry. It is widely used as an initial step for producing more refined or effective 3D representations from a collection of images because of its simplicity. Given a set of images or video consisting of texture and depth information and camera parameters (intrinsics and extrinsics) used to record the imagery, it is possible to reproject the pixels from the images or video back into 3D space as a point cloud. Simple pinhole camera reprojection formula is as follows:

$$\begin{matrix}X = \frac{z \times ( x - {c}_{x} )}{{f}_{x}} \\ Y = \frac{z \times ( y - {c}_{y} )}{{f}_{y}} \\ Z = z\end{matrix}$$

Other variations of the formula exist depending on the format of the input data and the camera model. This formula illustrates well how the focal lengths (f) of the camera along with the principal point (c) affect the 3D position (X,Y,Z) of points in the reconstructed point cloud. Focal length and principal point are the parameters that would be immediately affected when an image is cropped or otherwise transformed after it has been recorded with a camera.

It should be noted that it is common to use full projection matrix of the camera for the calculations, which for multicamera scenarios includes also extrinsic parameters of the camera, which indicate its transformation in 3D space related to commonly agreed origin.

Structure from Motion

Structure from motion (SfM) is a photogrammetric imaging technique for estimating three-dimensional structures from two-dimensional image sequences taken from different viewpoints that may be coupled with local motion signals. SfM can both estimate the camera parameters and the 3D geometry of the scene. It is studied in the fields of computer vision and visual perception. Most recently it has been adopted widely in the field of volumetric representations such as neural explicit radiance fields and 3D Gaussian splatting.

In general, SfM works as follows:
Collect overlapping images or videos of the scene from different angles;
Detect features from input frames;
Find feature correspondence between differing input frames;
Use the matching features to estimate relative positions and orientations of the cameras (calculate the fundamental projection matrix of the camera);
Reproject the feature matches into 3D using the estimated camera poses;
Refine the pose estimates to get better alignment of features in 3D by minimizing the reprojection error;
Iterate over the refinement steps until sufficient quality of reconstructed data is reached or the number of iterative cycles is exceeded.

Structure from motion algorithms and libraries may ingest multiple overlapping input images or videos to calculate relative positions and orientations of the input views. It is an efficient technique for camera pose estimation with bundle adjustment capability that calculates many individual camera parameters to find a solution for the scene that minimizes the global reprojection error. However, the bundle adjustment with the modern solutions is limited to the parameters that it can adjust and introducing more parameters fast increases the complexity of the bundle adjustment task. If such algorithms or libraries encounter frames that were cropped from the original videos or images, they are highly likely to result in errors in their output, because they can no longer fit a traditional pinhole/perspective camera model for the images without considering also the entire space, from where these images could possibly have been cropped from. This space is unlimited in theory. It can vastly increase the complexity of the pose estimation task and in all likelihood it will often fail or produce incorrect results.

CleanApertureBox as defined in ISO/IEC 14496-12 can be used as the basis for signaling cropping in an image or video. The semantics of the box indicate that the original video or image is present in the file uncropped, and the CleanApertureBox indicates the region from the original frame that should be displayed. The cropping is therefore handled as a post-process after reading the video or image bitstream from the file. Therefore, there does not seem to be a solution in ISO/IEC 14496-12 that would allow signaling for a scenario, where the cropping of the image/video has already been applied for the stored video frame or image and which would also describe the applied cropping operations. This type of information would be particularly useful in application, which aims to utilize the cropped stored images/video to produce a 3D representation from the imagery.

Derived video tracks, as in ISO/IEC 23008-16, cannot indicate cropping operation, since derived video tracks generate samples as a result of input images or video samples that are stored in the ISOBMFF file format.

The problem of missing applied cropping operations information on an image/video become even more clear when a cropped image/video is associated with a depth image/video and camera parameters of the system that captured the image/video pair. Using the cropped image/video and the camera parameters, would not allow to accurately reconstruct a 3D representation from the input data. This is why in volumetric videos, this information is embedded in the metadata that describes how the input data was processed and stored in the encoded volumetric video bitstreams.

The present embodiments provide a signaling and storage mechanism for videos and images (later referred to as frames of visual media data) which have been edited from its original source, while also storing information of the applied editing operations. A concrete example of the type of editing operation is cropping, which when applied to the frames of visual media data changes the resolution of the frames of visual media data. The parameters of the cropping operation that are applied to the frames of visual media data can then be stored along with the modified frames to allow reconstructing the original frames extents when needed. The parameters of the editing operations are needed for correctly reconstructing the 3D representation of the scene or object captured in the imagery.

The present embodiments cover a case, where the editing operation has already been applied to the image or video frames before the image or video frames are stored to ISOBMFF file. The operation of cropping images/video frames before storing to ISOBMFF file may reduce the size of data required.

An example of how a editing operation is applied to visual media data can contain the following steps:
Receive one or more frames of visual media data. This can happen directly or indirectly from a remote device located within any type of network. Additionally, the one or more frames to be edited may be received from a local hardware or software;
Receive editing instructions for the one or more frames of visual media data. The editing instructions may be received from a local hardware or software, or can be provided by software though appropriate interface.;
Record the original parameters of the one or more frames of visual media data;
Apply editing operations as instructed to the one or more frames of visual media data; and
Store the one or more modified frames of visual media data in a file along with the applied editing instructions and the original parameters of the one or more frames of visual media data.

An example on how the parsing operation of the visual media data can contain the following steps:
Receive a file consisting of
   one or more frames of visual media data,
   zero or more applied editing instructions per frame of visual media data, and
   original parameters of the one or more frames of visual media data;
The file may be received directly or indirectly from a remote device located within any type of network. Alternatively, the file may be received from local hardware or software.
Parse the file structures to extract the one or more frames of visual media data;
Parse the file structures to determine if and what editing operations have been applied to the one or more frames of visual media data;
Parse the file structures to determine what were the original parameters of the one or more frames of visual media data;
Pass at least the one or more frames of visual media data, the associated applied editing instructions and the original parameters of the one or more frames of visual media data to an application. An example of the application is a graphic rendering application that utilize the provided information to visualize the media data to a user.

In the following some examples of signaling and storing are listed:
In one embodiment the editing operations could consist of cropping operation that is parameterized by at least one set of vertical and horizonal offsets of the cropped region and width and height of the cropped region in the original video.
In one embodiment the original parameters of the one or more frames of visual media data consist at least original width and height of the one or more frames of visual media data, before editing was applied.
In one embodiment the file is structured according to ISOBMFF.
   In one embodiment the file is segmented ISOBMFF file.
In one embodiment a box is introduced for storing the applied editing instructions on the original image/video frames.
   In one embodiment the box can contain the cropping information.
   In another embodiment the box can contain rotation information.
   In another embodiment the box can contain skewing information.
   In another embodiment the box can contain scaling information.
   In another embodiment the box can contain color transformation information such as adjustments of white balance, exposure, contrast, saturation.
   In another embodiment the box can contain sharpening or blurring information.
   In another embodiment the box can contain depth transformation information.
In one embodiment, applied editing instruction history is stored for the one or more frames of video/images describing which editing operations have been applied to the stored one or more modified frames of video/images and in which order.

To enable signaling and storage of editing information on the original frames of visual media data is beneficial for a wide range of image processing algorithms depending on the application, for example re-projection of images to three dimensions or structure from motion (SfM). The present embodiments propose how to preserve such information in a file format along with the original parameters of the visual media frames.

According to embodiment, the original resolution of the source frames of visual media data along with the applied cropping operations is recorded in a container/file. In the container, the source resolution and the applied cropping operations are associated with the correct frames in the container/file. If the cropping operations change over time, the per frame information of the applied cropping operations is stored in the file.

The following sections are roughly categorized to accommodate different embodiments.

### Source Resolution

According to an embodiment, the original source resolution of the frames of visual media data is signaled by a dedicated box. The 4CC for the new box can be for example ‘sres’.

```
class SourceResolutionBox extends Box(‘sres’){
  unsigned int(32) width;
  unsigned int(32) height;}
```

wherein width and height disclose the source resolution of the image or video as pixels before any cropping other transformation has been applied.

In one embodiment a SourceResolutionBox is defined as an extension of EditInformationBox

```
class SourceResolutionBox extends EditInformationBox(‘sres’){
  unsigned int(32) width;
  unsigned int(32) height;}
```

In an embodiment, pixel density information may also be signaled per each resolution component.

In an embodiment, the data structure that contains the original width and height information can be stored as sample auxiliary information, which may be referenced by sample auxiliary information offset box (saio), with a well-defined aux_info_type. An example of such type can be for example ‘sres’ or any other 32 bit value. There may also be several aux_info_type_parameter values defined for such an auxiliary information. Such sample auxiliary information can be present for each video track sample.

In another embodiment, an entity group may be defined to associate a source resolution to many items or video tracks. A new entity group entity to group box 4CC can be defined to indicate this entity grouping. This type can be ‘sres’ and may be extended from EntitytoGroupBox with a data structure as defined above for SourceResolutionBox. There may be multiple such entity groups which group images or tracks that have different source resolutions.

### Applied Editing Operations

An example of the applied editing operations is a cropping operation.

There are two alternative designs for signaling the applied cropping operations. In one embodiment the CleanApertureBox can be leveraged and the semantics can be updated when SourceResolutionBox is present in the same container box (see above section). This requires fewer changes to specification but can be confusing and lead to errors in a situation where a legacy parser encounters CleanApertureBox but does not understand the updated semantics because SourceResolutionBox is not recognized. At worse, it may fail to display the image or video correctly. Because boxes do not support versioning the alternative solution is to introduce a new box that would be dedicated to signaling applied cropping operations (AppliedCroppingBox).

In the first embodiment, the semantics of CleanApertureBox is updated:
cleanApertureWidthN, cleanApertureWidthD are fractional numbers defining the width of the clean aperture image. When SourceResolutionBox is present in the same container, the fractional number defines the horizontal width of the cropping operations that have been applied on the data.
cleanApertureHeightN, cleanApertureHeightD are fractional numbers which define the height of the clean aperture image. When SourceResolutionBox is present in the same container, the fractional number defines the vertical height of the cropping operations that have been applied on the data.
horizOffN, horizOffD are fractional numbers defining the horizontal offset between the clean aperture image centre and the full aperture image centre. Typically, the number may be 0. When SourceResolutionBox is present in the same container, the fractional number defines the horizontal offset of the cropping operations that have been applied on the data.
vertOffN, vertOffD are fractional numbers defining the vertical offset between clean aperture image centre and the full aperture image centre. Typically, the number may be 0. When SourceResolutionBox is present in the same container, the fractional number defines the vertical offset of the cropping operations that have been applied on the data.

CleanApertureBox flags field may be defined to signal the presence of such source width and height and alike information. The semantics of the CleanApertureBox can be updated as well to explicitly indicate that the cropping operations as described in the offsets in the box have already been applied to the associated video or image.

In another embodiment, a new version of CleanApertureBox may be defined which would contain the source width and height information.

In the alternative embodiment we introduce a new AppliedCroppingBox for signaling applied cropping operations. As an example ‘acro’ 4CC could be reserved for the box.

```
class AppliedCroppingBox extends Box(‘acro’){
  unsigned int(32) width;
  unsigned int(32) height;
  unsigned int(32) horizOff;
  unsigned int(32) vertOff; }
```

where
width, height are values defining the size of the cropped region in the frame as pixels.
horizOff is a value which defines the horizontal offset of the cropped region in the frame as pixels.
verticalOff is a value which defines the vertical offset of the cropped region in the frame as pixels.

In another embodiment, fractional variables for the AppliedCroppingBox are used. This means that each variable is divided into two nominator and denominator. This allows signaling sub-pixel level cropping operations, which may sometimes be needed.

In yet another alternative, all signaling could be combined into a single box. The name and 4CC code of the box are reused in the previous embodiment.

```
class AppliedCroppingBox extends Box(‘acro’){
  unsigned int(32) origWidth;
  unsigned int(32) origHeight;
  unsigned int(32) horizOff;
  unsigned int(32) vertOff; }
```

wherein
origWidth, origHeight are values defining the size of the original frame as pixels before any cropping or other transformation was done.
horizOff is a value which defines the horizontal offset of the cropped region in the frame as pixels.
verticalOff is a value which defines the vertical offset of the cropped region in the frame as pixels.

It is to be noted that the current width and height (after the cropping has been applied) of the video or image can be derived from the visual sample entry.

In one embodiment a AppliedCroppingBox is defined as an extension of EditInformationBox:

```
class AppliedCroppingBox extends EditInformationBox(‘sres’){
  unsigned int(32) width;
  unsigned int(32) height;
  unsigned int(32) horizOff;
  unsigned int(32) vertOff; }
```

### Linking of Source Resolution and Applied Editing Operations

According to an embodiment, the syntax structures as proposed are associated with the visual media data. One way to do this is to embed this information in the visual sample entry when it can be applied to the entire image/video contained in the track. There might also be a reason to be able to signal this information per frame in the video, which can be done by introducing a sample group that uses the box structures.

In one embodiment the cropping information can be added in the visual sample entry of the track that the information applies to.

```
class VisualSampleEntry(codingname) extends SampleEntry (codingname){
  unsigned int(16) pre_defined = 0;
  const unsigned int(16) reserved = 0;
  unsigned int(32)[3] pre_defined = 0;
  unsigned int(16) width;
  unsigned int(16) height;
```

| | |
|---|---|
| template unsigned int(32) horizresolution = 0x00480000; | // 72 dpi |
| template unsigned int(32) vertresolution = 0x00480000; | // 72 dpi |

```
  const unsigned int(32)reserved = 0;
  template unsigned int(16) frame_count = 1;
  uint(8)[32] compressorname;
  template unsigned int(16) depth = 0x0018;
  int(16) pre_defined = −1;
  // other boxes from derived specifications
```

| | | |
|---|---|---|
| CleanApertureBox | clap; | // optional |
| PixelAspectRatioBox | pasp; | // optional |
| AppliedCroppingBox | acro; | // optional |
| SourceResolutionBox | sres; | // optional |

}

### Signaling of Editing Operation in Formation for ISO/IEC 230008-12

Where editing operation is cropping, source resolution and/or cropping information can be signaled as an item property. This applies especially for image items. Such item property may be a descriptive item property, with an example 4CC code ‘sres’. Such property may be associated with many image items that have the same source resolution and or cropping.

There may be two independent item properties defined: One for source resolution, another one for the cropping operation. This will enable efficient usage of properties on different items where source resolutions or cropping offsets are different.

The following could be the example item properties:

```
aligned(8) class SourceResolutionProperty
  extends ItemFullProperty(‘srep’, version = 0, flags = 0)
{
  SourceResolutionBox sres;
}
```

In another embodiment, source width and height information may be directly embedded in the property:

aligned(8) class SourceResolutionProperty
extends ItemFullProperty(‘srep’, version = 0, flags = 0)
{
unsigned int(32) width;
unsigned int(32) height;
}

The same could be applied to applied cropping property

```
aligned(8) class SourceResolutionProperty
  extends ItemFullProperty(‘srep’, version = 0, flags = 0)
{
  AppliedCroppingBox acro;
}
```

In another embodiment, cropping information may be directly embedded in the property:

aligned(8) class AppliedCroppingProperty
extends ItemFullProperty(‘acrp’, version = 0, flags = 0)
{
unsigned int(32) horizOff;
unsigned int(32) vertOff;
}

In another embodiment, image items that have the same source resolution may be grouped using an entity group and a new entity grouping type may be defined to include the Source Resolution or applied cropping.

### Alternative Applied Editing Operations.

In the previous embodiments, the editing operation has been discussed from a point of view of cropping operation. However, as was mentioned earlier, cropping is one of the example, and there are other editing operations which can be implemented similarly. These operations could include but are not limited to:
Signaling applied rotation of frames of visual media data;
Signaling applied skewing of frames of visual media data;
Signaling applied scaling of frames of visual media data;
Signaling applied color transformation information such as adjustments of white balance, exposure, contrast, saturation of frames of visual media data;
Signaling applied sharpening or blurring of frames of visual media data;
Signaling applied depth changes of frames of visual media data.

### Video/Image Edit History

In one embodiment, a new box is introduced that contains information about all edits performed to the original content to achieve the current version of images/video frames stored in a container/file. The 4CC for the new box can be, for example, ‘ehis’.

class EditHistoryBox extends Box(‘ehis’){
EditInformationBox [ ];}

The EditHistoryBox contains EditInformationBox. According to an embodiment EditInformationBox is defined as

aligned(8) class EditInformationBox (unsigned int(32) edit_type) extends
Box(edit_type) {
}

In one embodiment EditInformationBox is defined as

aligned(8) class EditInformationBox (unsigned int(32) edit_type) extends
Box(edit_type) {
unsigned int(32) edit_order_idx;}

where edit_order_idx provides an index among all EditInformationBox in EditHistoryBox and there shall be at most one EditInformationBox with a given edit_order_idx in a EditHistoryBox. Edit_order_idx can overlap in boxes corresponding to the same content. Matching index values simply mean that the operations were performed simultaneously and order of applied operations does not change the outcome.

EditInformationBox may contain other boxes that describe the applied editing operations in more detail. EditingInformationBox and EditHistoryBox merely indicate the history and order of the applied editing operations

In one embodiment edit_order_idx provide information in what order the edits were performed. For example, a EditHistoryBox A with edit_order_idx X was done before EditHistoryBox B with edit_order_idx Y when X is smaller than Y, or vice versa.

In one embodiment order of EditInformationBox in EditHistoryBox provide the information about the order of edits performed on the original content.

In one embodiment EditInformationBox is defined as

```
aligned(8) class EditInformationBox (unsigned int(32)
edit_type) extends Box(edit_type)
{
  unsigned int(32) edit_order_idx;
  unsigned int(32) track_ID;}
```

where track_ID indicates to which track this edit was applied.

In one embodiment EditInformationBox is defined as

```
aligned(8) class EditInformationBox (unsigned int(32)
edit_type) extends Box(edit_type)
{
  unsigned int(32) edit_order_idx;
  unsigned int(32) entity_ID;}
```

where entity_ID indicate to which entity (track/item) this edit was applied.

In one embodiment EditHistoryBox is stored in sample entry of the edited track containing video bitstream.

In one embodiment EditHistoryBox is stored as part of an item property, for example EditHistoryItemProperty in ItemPropertyContainerBox of an image item.

In one embodiment EditHistoryBox is stored in samples of metadata track describing the video track.

In one embodiment EditHistoryBox is stored in sample group associated with video track

### Edit History Sample Grouping

In an embodiment, the edit history sample group with 4cc (‘edhi’) may be defined. Any other name and 4cc may be used. The edit history sample group may be used to signal the information about all edits performed to the original content of samples in a video track. In an embodiment, when all edits performed to the original content of the samples within a track change dynamically and a static value in a EditHistoryBox in a sample entry, cannot therefore be used.

In an embodiment, when the edit history sample group is used in a track, the EditHistoryBox shall not be present in any sample entry of that track.

Syntax may be as follows:

class EditHistoryEntry( ) extends VisualSampleGroupEntry (‘edhi’)
{EditInformationBox [ ];}

In one embodiment EditHistoryBox is stored in track group.

### Signaling Timed Editing for Video

The editing operations may need to be signaled per frame or for a sequence of frames in a track. There may for example be a person that walks in the video frame that is cropped individually every frame.

For such embodiment, a new sample group can be defined:

```
class AppliedCroppingEntry( ) extends VisualSampleGroupEntry (‘acrg’){
  unsigned int(32) horizOff;
  unsigned int(32) vertOff;
}
```

### Wherein

horizOff is a value which defines the horizontal offset of the cropped region in the frame as pixels.
verticalOff is a value which defines the vertical offset of the cropped region in the frame as pixels.

It is to be noticed that the original width and height (before applying the editing, such as cropping) of the video or image is not changing over time. Instead, these can be derived from the SourceResolutionBox in the sample entry of the track. Similarly, the current width and height of the video can be derived from the visual sample entry.

In another embodiment, sample auxiliary information is used to indicate per sample cropping offsets.

In yet another embodiment a new metadata track may be defined that consists of samples that define the cropping offsets per frame. The metadata track is then associated with the track the contains the modified video either by track reference or by storing both of the tracks in the same track group.

In an embodiment, a new box at track level could be defined to include per-sample applied cropping and source resolution. This may be the preferred option especially if the file creator wishes to avoid too many sample entry definitions, nearly one per video sample.

```
aligned(8) class SampleCroppingInformationBox extends
FullBox(‘scib’, version = 0, 0)
{
  unsigned int(32) entry_count;
  for (i=1; i <= entry_count; i++) {
      unsigned int(32) sample_count;
  AppliedCroppingBox acro;
    }
}
```

### Wherein

entry_count is an integer that gives the number of entries in the following table
sample_count is an integer that gives the number of consecutive samples in the track where the cropping defined by the applied cropping box applies. In an embodiment, offset information and other data structures could be directly embedded without using the AppliedCroppingBox. AppliedCroppingBox is just an example.

In this case, offset information use the source width and height information as original resolution information.

Similarly, source resolution for each sample could be defined by a dedicated bow which is at track level as follows as an example:

```
aligned(8) class SampleSourceResolutionBox extends
FullBox(‘ssrb’, version = 0, 0)
{
  unsigned int(32) entry_count;
  for (i=1; i <= entry_count; i++) {
unsigned int(32) sample_count;
  SourceResolutionBox sres;
  }
}
```

### Wherein

entry_count is an integer that gives the number of entries in the following table
sample_count is an integer that gives the number of consecutive samples in the track where the cropping defined by the applied cropping box applies. In an embodiment, source width and height and other data structures could be directly embedded without using the SourceResolutionBox. SourceResolutionBox is just an example.

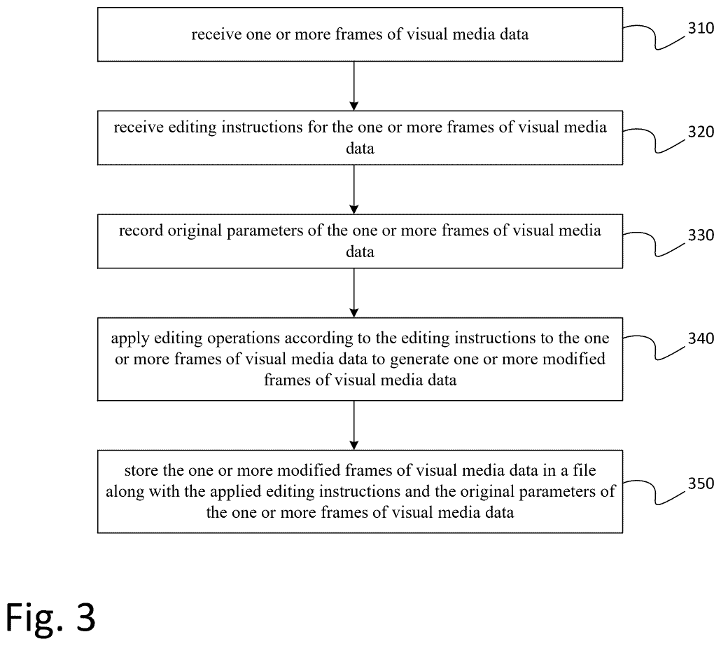

FIG. 3 is a flowchart illustrating a method for encoding according to an embodiment. The method shown in FIG. 3 comprises receiving 310 one or more frames of a visual media data; receiving 320 editing instructions for the one or more frames of visual media data; recording 330 original parameters of the one or more frames of visual media data; applying 340 editing operations according to the editing instructions to the one or more frames of visual media data to generate one or more modified frames of visual media data; and storing 350 the one or more modified frames of visual media data in a file along with the applied editing instructions and the original parameters of the one or more frames of visual media data. The steps of the method as shown in FIG. 3 and as discussed in previous embodiments can be implemented with a respective computer module of a computer system.

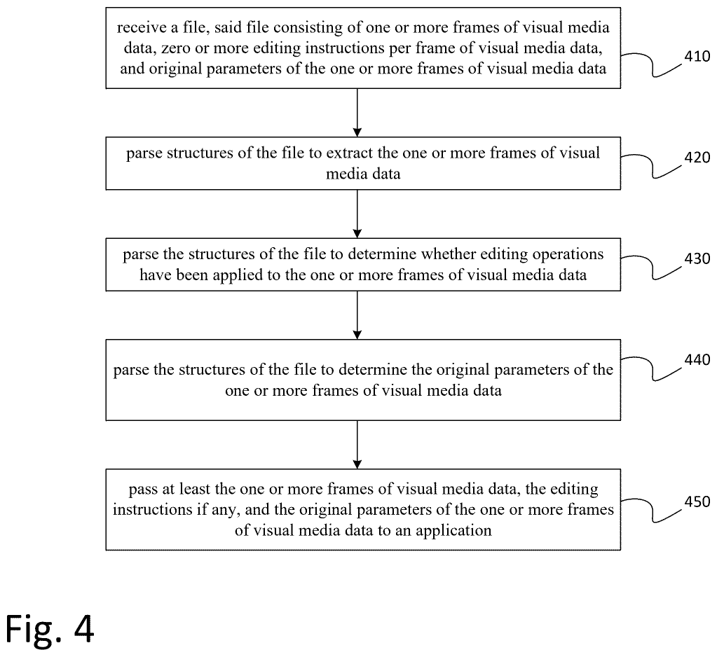

FIG. 4 is a flowchart illustrating a method for decoding according to an embodiment. The method shown in FIG. 4 comprises receiving 410 a file, said file consisting of one or more frames of visual media data, zero or more editing instructions per frame of visual media data, and original parameters of the one or more frames of visual media data; parsing 420 structures of the file to extract the one or more frames of visual media data; parsing 430 the structures of the file to determine whether editing operations have been applied to the one or more frames of visual media data; parsing 440 the structures of the file to determine the original parameters of the one or more frames of visual media data; and passing 450 at least the one or more frames of visual media data, the editing instructions, if any, and the original parameters of the one or more frames of visual media data to an application. The steps of the method as shown in FIG. 4 and as discussed in previous embodiments can be implemented with a respective computer module of a computer system.

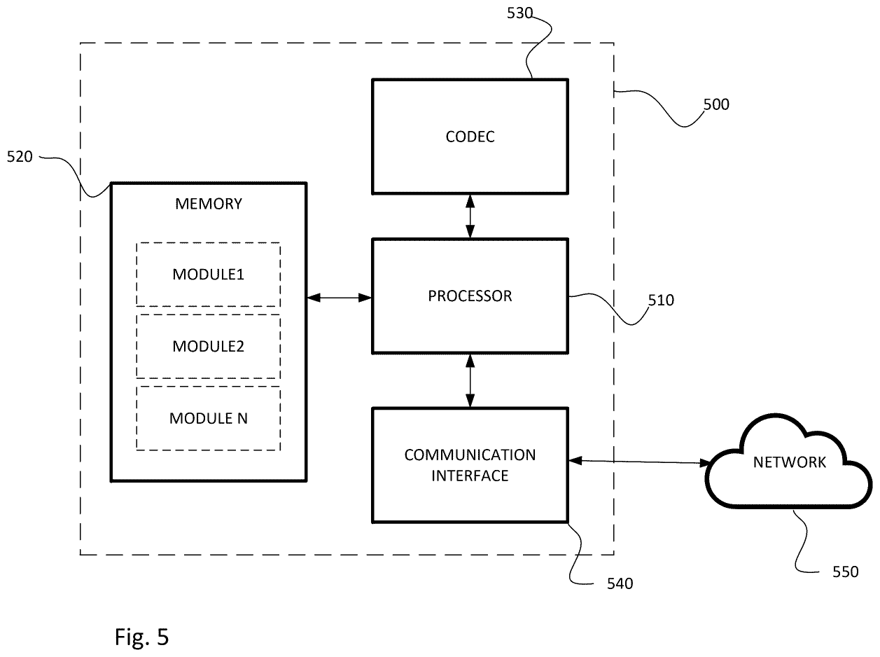

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

FIG. 5 illustrates an example of an electronic apparatus 500, being an example of video coding system where the present embodiments can be implemented. In some embodiments, the apparatus may be a mobile terminal or a user equipment of a wireless communication system or a camera device. The apparatus 500 may also be comprised at a local or a remote server or a graphic processing unit of a computer. The apparatus may also be comprised as part of a head-mounted display device.

The apparatus 500 comprises one or more processors 510 and one or more memories 520 and one or more transceivers interconnected through one or more buses. The one or more memories 520 store computer instructions, for example in respective modules (Module1, Module2, ModuleN). The one or more memories may store data in the form of image, video and/or audio data, and/or may also store instructions to be executed by the processors or the processor circuitry. The one or more processors may comprise a central processing unit (CPU) and/or a graphical processing unit (GPU). The one or more buses may be address, data or control buses, and may include interconnection mechanism, such as a series of lines on a motherboard or integrated circuit, fiber optics or other optical communication equipment. The apparatus also comprises a codec 530 that is configured to implement various embodiments relating to present solution. According to some embodiments, the apparatus may comprise an encoder or a decoder. The apparatus 500 also comprises a communication interface 540 which is suitable for generating wireless communication signals for example for communication with a cellular communications network, a wireless communications system, or a wireless local area network, and thus enabling data transfer over data transfer network 550.

The apparatus 500 may comprise a display in the form of a liquid crystal display. In other embodiments of the invention the display may be any suitable display technology suitable to display an image or video. The apparatus 500 may further comprise a keypad. In other embodiments of the invention any suitable data or user interface mechanism may be employed. For example, the user interface may be implemented as a virtual keyboard or data entry system as part of a touch-sensitive display. The apparatus 500 may comprise a microphone or any suitable audio input which may be a digital or analogue signal input. The apparatus 500 may further comprise an audio output device which in embodiments of the invention may be any one of: an earpiece, speaker, or an analogue audio or digital audio output connection. The apparatus 600 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 530 or to processor 510. The apparatus may receive the video and/or image data for processing from another device prior to transmission and/or storage.

The apparatus 500 may further comprise e.g., the other functional units disclosed e.g., in FIG. 1 for implementing any of the present embodiments.

The apparatus may operate in a system, comprising multiple communication devices, which can communicate through one or more networks. The system may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system can be a mobile telephone network enabling a connection to the internet. The connection can form, but is not limited to, long range wireless connections, short range wireless connections, and various wired connections including, but not limited to, telephone lines, cable lines, power lines, and similar communication pathways.

The example communication devices operating in the system may include, but are not limited to, an electronic device or apparatus, a combination of a personal digital assistant (PDA) and a mobile telephone, a PDA, an integrated messaging device (IMD), a desktop computer, a notebook computer, each of which can be a representative of the apparatus according to present embodiments. The apparatus according to present embodiments may be stationary or mobile when carried by an individual who is moving. The apparatus may also be located in a mode of transport including, but not limited to, a car, a truck, a taxi, a bus, a train, a boat, an airplane, a bicycle, a motorcycle, or any similar suitable mode of transport.

The apparatus may also be a set-top box; i.e. a digital TV receiver, which may/may not have a display or wireless capabilities, a tablet or (laptop) a personal computer (PC), which have hardware or software or combination of the encoder/decoder implementations, in various operating systems, or a chipset, processor, DSP and/or embedded system offering hardware/software based coding.

The apparatus according to present embodiments may send and receive calls and messages and communicate with service providers through a wireless connection to a base station. The base station may be connected to a network server that allows communication between the mobile telephone network and the internet.

The apparatus may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

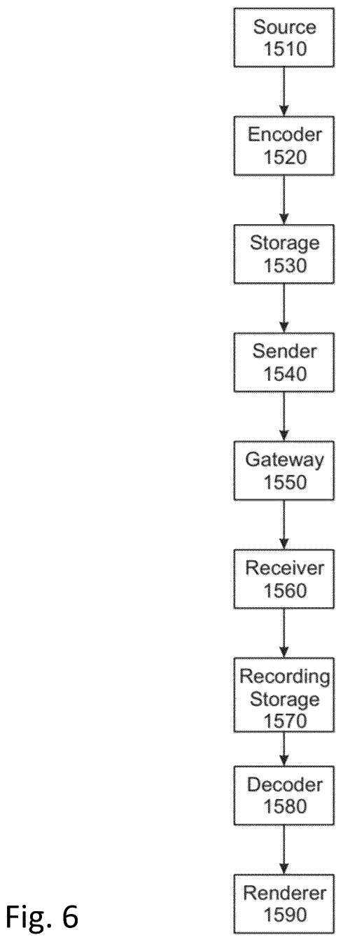

FIG. 6 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be encoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random-access memory. The format of the coded media bitstream in the recording storage 2170 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams.

Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g., for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1580 is discussed to simplify the description without a lack of generality.

The coded media bitstream may be processed further by a decoder 1580, whose output is one or more uncompressed media streams. Finally, a renderer 1590 may reproduce the uncompressed media streams with a loudspeaker or a display, for example. The receiver 1560, recording storage 1570, decoder 1580, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally, or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

A decoder 1580 may be configured to perform switching between different representations e.g., for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with reference to and/or using terminology of HEVC and/or VVC. It needs to be understood that embodiments may be similarly realized with any video encoder and/or video decoder.

If desired, the distinct functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising: at least one processor; and at least one memory including computer program code, the at least one memory and the computer program code configured to, with the at least one processor, cause the apparatus to perform at least the following: receive one or more frames of visual media data; receive editing instructions for the one or more frames of visual media data; record original parameters of the one or more frames of visual media data; apply editing operations according to the editing instructions to the one or more frames of visual media data to generate one or more modified frames of visual media data; and store the one or more modified frames of visual media data in a file along with the applied editing instructions and the original parameters of the one or more frames of visual media data.

2. The apparatus according to claim 1, wherein the one or more frames of visual media are received as an encoded bitstream.

3. The apparatus according to claim 1, wherein the one or more modified frames of visual media are encoded into a bitstream and stored in a file.

4. The apparatus according to claim 1, wherein editing instructions comprises cropping operation.

5. The apparatus according to claim 4, wherein the cropping operation is parameterized by at least one set of vertical and horizontal offset of a cropped region and width and height of the cropped region in the original frame of visual media data.

6. The apparatus according to claim 1, wherein the file is structured according to ISO base media file format.

7. The apparatus according to claim 6, wherein the file comprises a box for storing the applied editing instructions.

8. The apparatus according to claim 7, wherein the box comprises one or more of the following: cropping information; rotation information; skewing information; scaling information; color transformation information; sharpening information; blurring information; depth transformation information.

9. The apparatus according to claim 3, wherein the editing information is stored in the encoded bitstream as supplementary enhancement information messages.

10. The apparatus according to claim 1, further being caused to store the applied editing instruction history for the one or more frames of visual media data, the history describing the applied editing instructions and the order of the applied editing instructions.

11. An apparatus comprising: at least one processor; and at least one memory including computer program code, the at least one memory and the computer program code configured to, with the at least one processor, cause the apparatus to perform at least the following: receive a file, wherein the file comprises one or more frames of visual media data, zero or more editing instructions per frame of visual media data, and original parameters of the one or more frames of visual media data; parse structures of the file to extract the one or more frames of visual media data; parse the structures of the file to determine whether editing operations have been applied to the one or more frames of visual media data; parse the structures of the file to determine the original parameters of the one or more frames of visual media data; and pass at least the one or more frames of visual media data, the editing instructions if any, and the original parameters of the one or more frames of visual media data to an application.

12. The apparatus according to claim 11, wherein the editing instructions comprises cropping operation.

13. The apparatus according to claim 12, wherein the cropping operation is parameterized by at least one set of vertical and horizontal offset of a cropped region and width and height of the cropped region in the original frame of visual media data.

14. The apparatus according to claim 11, wherein the file is structured according to ISO base media file format.

15. The apparatus according to claim 14, wherein the file comprises a box for storing the applied editing instructions.

16. The apparatus according to claim 15, wherein the box comprises one or more of the following: cropping information; rotation information; skewing information; scaling information; color transformation information; sharpening information; blurring information; depth transformation information.

17. The apparatus according to claim 11, further being caused to store the applied editing instruction history for the one or more frames of visual media data, the history describing the applied editing instructions and the order of the applied editing instructions.

18. A method comprising: receiving a file, wherein the file comprises one or more frames of visual media data, zero or more editing instructions per frame of visual media data, and original parameters of the one or more frames of visual media data; parsing structures of the file to extract the one or more frames of visual media data; parsing the structures of the file to determine whether editing operations have been applied to the one or more frames of visual media data; parsing the structures of the file to determine the original parameters of the one or more frames of visual media data; passing at least the one or more frames of visual media data, the editing instructions if any, and the original parameters of the one or more frames of visual media data to an application.

19. The method according to claim 18, wherein the editing instructions comprises cropping operation.

20. The method according to claim 19, wherein the cropping operation is parameterized by at least one set of vertical and horizontal offset of a cropped region and width and height of the cropped region in the original frame of visual media data.
